(19) United States
(12) Patent Application Publication
(10) Pub. No.: US 2018/0360052 A1
(43) Pub. Date: Dec. 20, 2018

(54) WAFFLE PRODUCT CONTAINING INTEGRAL RESERVOIR AND METHOD OF MANUFACTURE THEREOF

(71) Applicant: The FIX, LLC, Providence, RI (US)

(72) Inventors: Michael K. Allio, Providence, RI (US); Stephen E. Lane, Providence, RI (US)

(21) Appl. No.: 16/002,497

(22) Filed: Jun. 7, 2018

Related U.S. Application Data
(60) Provisional application No. 62/521,845, filed on Jun. 19, 2017.

(51) Int. Cl. A21D 13/32; A21D 13/36; A21D 13/45; A21D 13/47

(52) U.S. Cl. CPC A21D 13/32; A21D 13/47; A21D 13/45; A21D 13/36

(57) ABSTRACT

A waffle is formed of a body having an integral reservoir formed therein with a plurality of severable waffle sections that are connected to the integral reservoir and configured so as to be severable from the integral reservoir such that the integrity of the integral reservoir is maintained when each severable waffle section is severed from the integral reservoir and are further configured to both capture and effectively direct and fluid toppings.

### CROSS-REFERENCE TO RELATED PATENT APPLICATION

This application is based on and claims priority to U.S. Provisional Patent Application 62/521,845, filed Jun. 19, 2017, the entire contents of which is incorporated by reference herein as if expressly set forth in its respective entirety herein.

### TECHNICAL FIELD

The present invention is related to a food product (foodstuff) and more particularly, is related to a waffle product that includes an integral reservoir and a plurality of waffle sections that can have a decorative appearance, such as flower petals, and are formed to surround the integral reservoir, and are further configured to both direct and capture fluid toppings, and be severed from the integral reservoir without jeopardizing the integrity of the reservoir.

### BACKGROUND

One of the more popular breakfast foods are waffles. Generally, a waffle is a food product made from batter or dough that is cooked between two plates that are patterned to give a characteristic size, shape and surface impression. There are many variations based on the type of waffle iron and recipe used. Waffles are eaten throughout the world, particularly in Belgium, which has many different regional varieties.

Waffles are typically eaten with dressings and/or toppings. For example, waffles are typically dressed with syrup, such as maple syrup or other flavored syrups. In addition, waffles are often enjoyed by applying other foods, such as fruits, jams, edible inclusions, ice-cream, etc. When a syrup is poured over the waffle, it often flows and spills over the waffle edge onto the plate and thus, is wasted unless a cut piece of waffle is then dipped and smeared with this syrup.

While many people associate waffles with breakfast, it will be understood that waffles are commonly eaten outside of a traditional breakfast time and instead can be eaten as a snack or lunch or even dinner.

Waffles can be made fresh by preparing the batter and then pouring the batter into the waffle iron or can simply be reheated after having been commercially precooked and frozen; some consumers prefer a pre-cooked waffle served at room temperature. A consumer will find many different waffle products in the frozen section of a traditional or natural food supermarket.

Conventional waffles are flat circles or rectangles, typically featuring shallow grids, offering limited volume for containing fluid or semi-fluid toppings, such as syrup and jam. Portability is constrained because syrup spreads across the surface rapidly and spills over the edges of the waffle since waffles are not typically designed with functional perimeter lips or rims. In addition, most conventional frozen waffles are not scored and therefore, the flat, planar surface is difficult to segment and separate cleanly without the use of utensils, which compels the consumer to consume waffle products while stationary (sitting or standing) over a plate.

There is therefore a desire to provide an alternative waffle product that contains or disperses fluid toppings effectively, and that can be efficiently and neatly severable, permitting both conventional or on-the-go consumption without the mess.

### SUMMARY

In accordance with one embodiment, a waffle is formed of a cooked body having an integral reservoir formed therein with a plurality of severable waffle sections that are connected to the integral reservoir and configured to be severable from the integral reservoir such that the integrity of the integral reservoir is maintained when each severable waffle section is severed from the integral reservoir.

### BRIEF DESCRIPTION OF THE DRAWING FIGURES

FIG. 1 is a top and side perspective view of a cooked waffle in accordance with one embodiment of the present invention;

FIG. 2 is a top plan view thereof;

FIG. 3 is a first side elevation view thereof;

FIG. 4 is a second side elevation view thereof;

FIG. 5 is a perspective view, in cross-section, of a portion of the waffle taken along a first axis;

FIG. 6 is a cross-sectional view in side elevation of the waffle taken along the first axis;

FIG. 7 is a perspective view, in cross-section, of a portion of the waffle taken along a first axis;

FIG. 8 is a cross-sectional view in side elevation of the waffle taken along the first axis; and

FIG. 9 is a perspective view of a cooking assembly for making the waffle of FIG. 1.

### DETAILED DESCRIPTION OF CERTAIN EMBODIMENTS

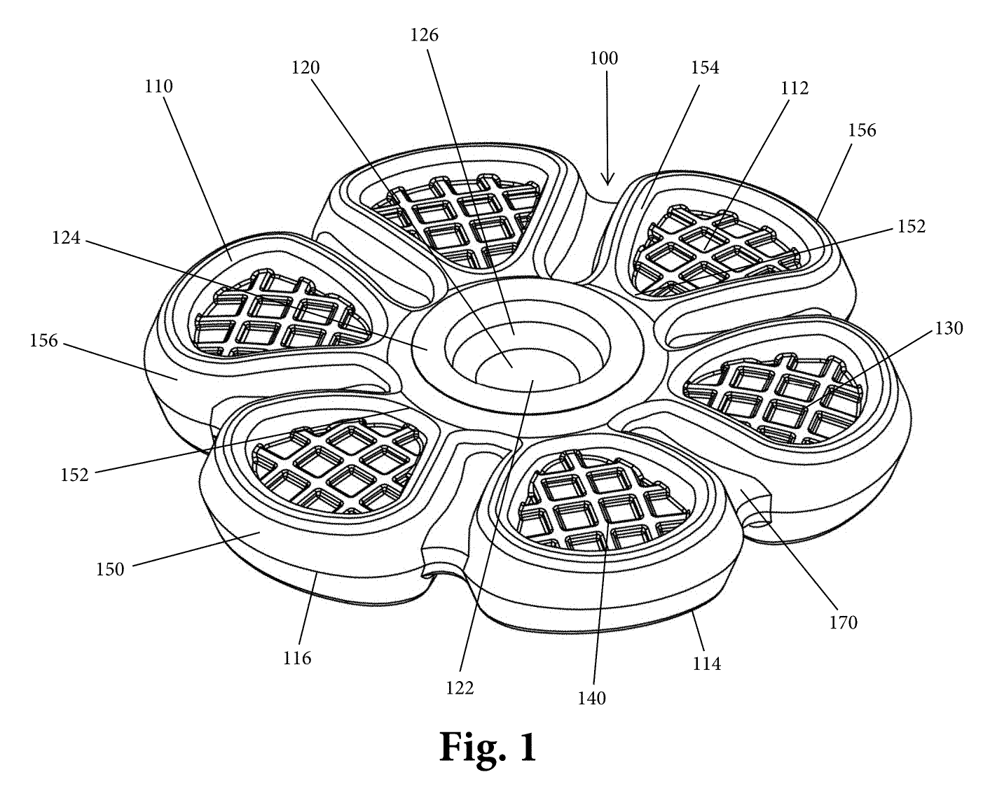

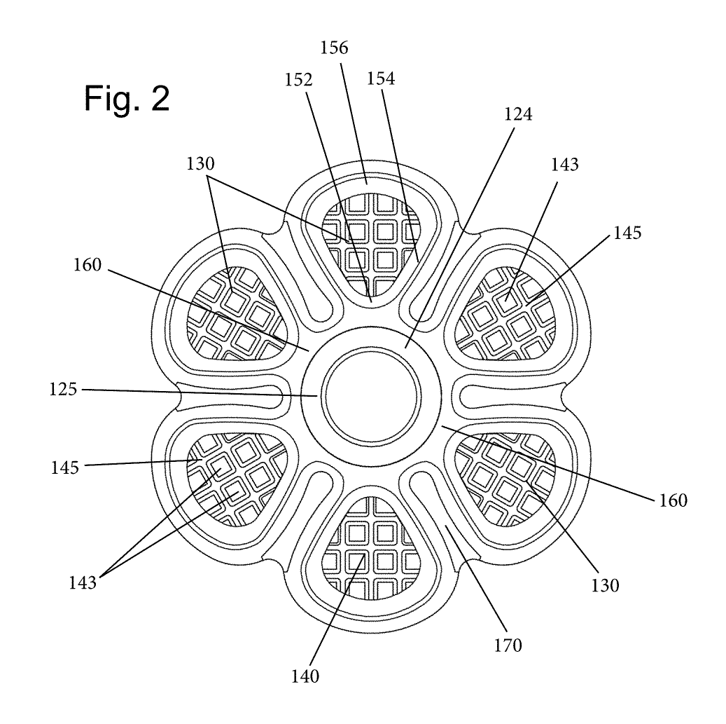

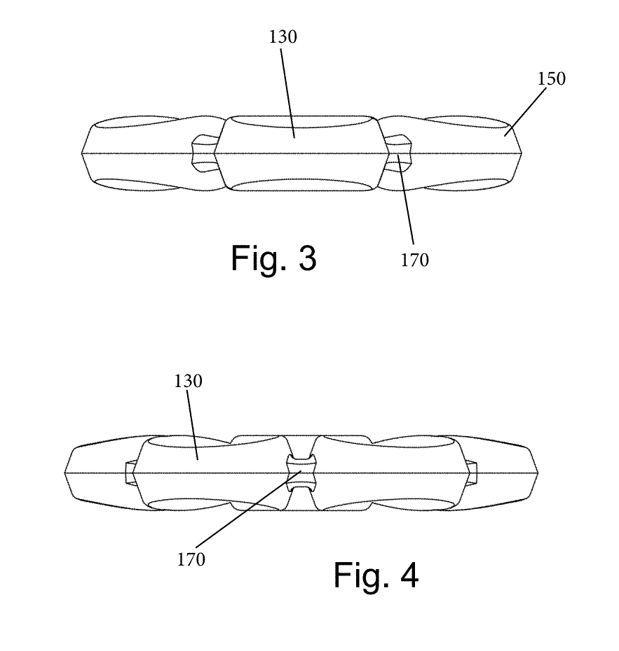

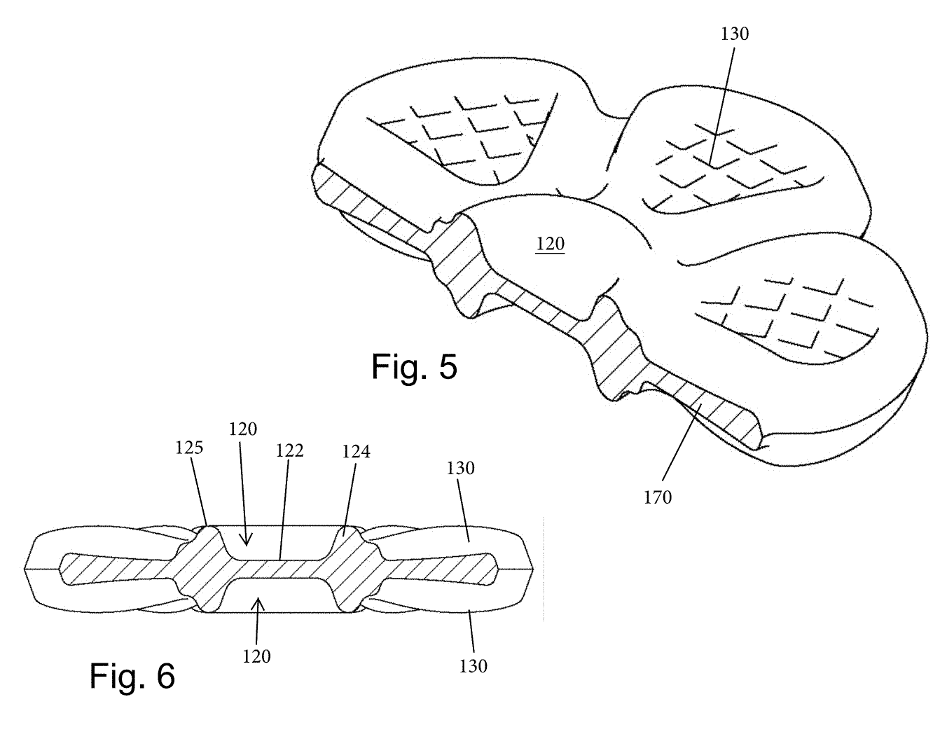

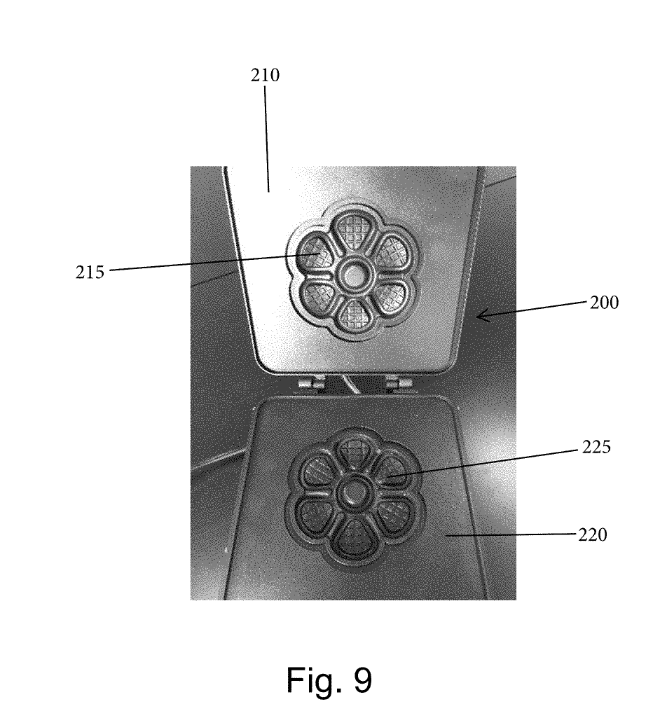

FIG. 1-8 illustrate a waffle product (waffle) 100 in accordance with one embodiment of the present invention. The waffle 100 is constructed such that it takes the form of and resembles a flower. The waffle 100 has a body 110 that is defined by a top surface 112, an opposing bottom surface 114 and a peripheral side edge (wall) 116. As described herein, the waffle 100 is formed to have a number of different structural features that are formed as part of the body 110 which is made of a single batter material. In other words, the body 110 is homogenous and formed from a batter source that is poured with molds of a cooking assembly (waffle iron) as described herein and as shown in FIG. 9.

As shown, the waffle 100 is constructed to have an integral reservoir 120 which in the illustrated embodiment is centrally located within the waffle body 110. The integral reservoir 120 is formed integrally within the body 110 and is open along the top surface 112. The reservoir 120 is defined by a floor (bottom wall) 122 and a side wall 124 that surrounds the floor 122 and extends upwardly therefrom. As shown in the figures, the side wall 124 can have an angled inner surface 126 and more particularly, the inner surface 126 can have an inward taper in a direction toward the floor 122.

The reservoir 120 can take any number of different shapes and is not limited to the circular shape that is illustrated in the figures and is merely exemplary and not limiting of the reservoir 120. In the illustrated embodiment, the floor 122 has a circular shape and the side wall 124 has a circumferential (annular) shape. The floor 122 can be a generally smooth surface or can be patterned and/or the side wall 124 can be a generally smooth surface or can be patterned. The floor 122 and the side wall 124 thus define the reservoir 120 that can receive a waffle dressing (e.g., maple syrup or flavored syrup) or waffle filling or other food products, such as fruit, ice cream, etc. that can be enjoyed on top of the waffle 100.

The height of the side wall 124 can be varied and/or the area of the floor 122 and circumference of the side wall 124 can be varied, thereby allowing the volume of the reservoir 120 to be varied. The side wall 124 terminates in a free top edge 125 that can be a rounded edge as shown.

Surrounding the integral reservoir 120 is a plurality of waffle sections 130 that are specifically constructed and formed, as described herein, to be easily and discretely severable from the integral reservoir 120 while maintain the integrity of the reservoir 120. In other words, a person can grasp and tear or otherwise remove one waffle section 130 in a direction away from the integral reservoir 120. The selected waffle section 130 is constructed to detach from the integral reservoir 120 in such a way that the integrity of the reservoir 120 is not jeopardized in that the floor 122 and side wall 124 remain intact resulting in the material within the reservoir 120 being contained.

In the illustrated embodiment in which each waffle section 130 resembles a flower petal, the person eating the waffle 100 can thus remove one petal at a time from the flower's center portion (e.g., stamen) which in waffle 100 is represented by the reservoir 120. The severable waffle sections 130 are therefore formed circumferentially about the reservoir 120. Each severable waffle section 130 includes a center or central portion 140 and a peripheral side wall 150 that extends around the center portion 140. As shown, the peripheral side wall 150 is elevated relative to a top surface of the center portion 140. In one embodiment, the peripheral side wall 150 is a continuous wall that completely surrounds the center portion 140. The peripheral side wall 150 in combination with a top surface 142 of the center portion 140 thus defines a peripheral reservoir, generally indicated at 150. As shown, the top surface 142 can be a patterned surface in that it can be defined by a series of wells 143 that are separated by ridges 145 (so as to form a grid pattern).

When the severable waffle section 130 resembles a flower petal (e.g., an elongated ellipse), the peripheral side wall 150 includes an inner wall portion 152 that faces and is spaced from the reservoir 120, a pair of inner side wall portions 154 and an outer wall portion 156 that is opposite the inner wall portion 153. Each of the inner wall portion 152 and outer wall portion 156 thus lie between and are integral to the inner side wall portions 154. Each of the inner wall portion 152, the inner side wall portion 154, and the outer wall portion 156 can have an arcuate shape as shown.

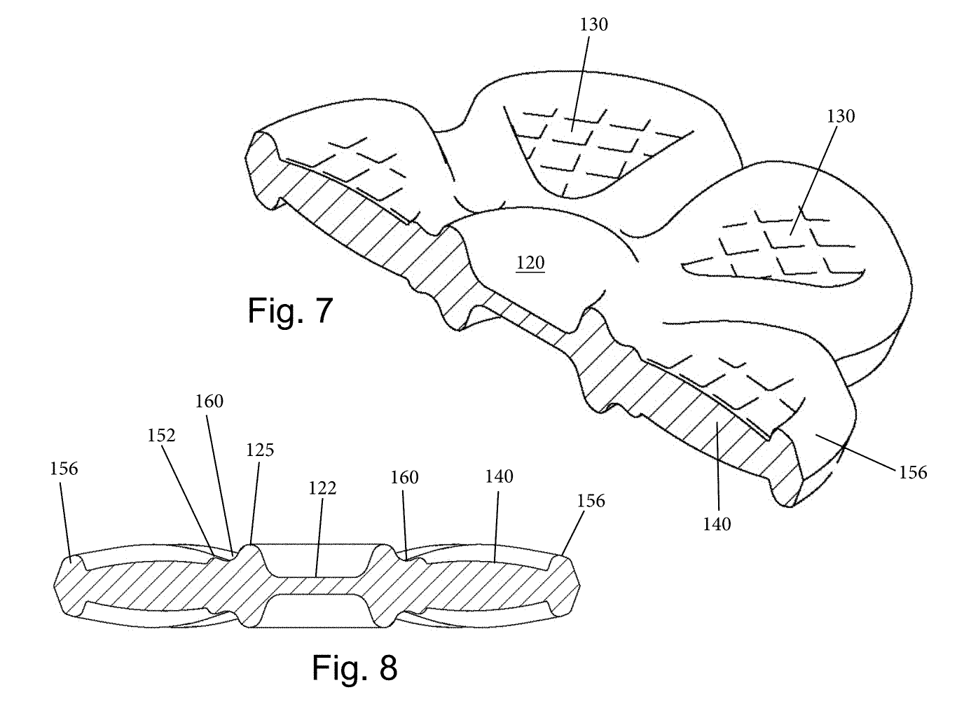

Each severable waffle section 130 is connected to the side wall 124 of the integral reservoir 120 by an inner connector wall 160 that connects the inner wall portion 152 of the severable waffle section 130 to the side wall 124 of the reservoir 120. As best shown in the cross-sectional views of FIGS. 7-8, the inner connector wall 160 has a reduced thickness relative to both the inner wall portion 152 and the side wall 124 of the reservoir 120. The inner connector wall 160 thus resembles a moat formed around the reservoir 120.

The reduced thickness of the inner connector wall 160 thus in effect acts as a score line (a first score line) or the like and represents a natural tear line (region or zone) for separating the severable waffle section 130 from the side wall 124 of the integral reservoir 120. The formation of this natural tear line (the inner connector wall 160) at the location between the side wall 124 of the reservoir 120 and the inner wall portion 152 ensures that the integrity of the reservoir 120 and the integrity of the severable waffle section 130 remain intact after separation. The integrity of the reservoir 120 is important since it is intended to hold contents, such as syrup, waffle filling, fruit, etc., and especially in the case of a flowable liquid, like syrup, the side wall 124 must remain intact to ensure that the liquid remains fully contained in the reservoir 120 and is available for dipping. In addition, it is desirable for the severable waffle section 130 to remain intact since when it is in the form of a petal, it is desirable for the entire decorative petal to remain intact when it is severed from the adjacent petals and from the integral reservoir 120.

As shown, each of the discrete severable waffle sections 130 is connected to the adjacent waffle sections 130 by thinned connecting walls or flanges (web) 170. The connecting walls 170 attach one peripheral inner side wall of one severable waffle section 130 to one peripheral side wall of an adjacent severable waffle section 130. These thin connecting walls 170 thus define score lines (second score lines) that promote severing one waffle section 130 from the adjacent waffle sections 130. Once again, this ensures that each severable waffle section 130 remains fully intact upon separation.

As shown, the side walls of adjacent waffle sections 130 can be beveled surfaces that protrude upwardly from the top surface of the connecting wall 170 and taper outwardly in a direction away from the connecting wall 170. The closed end of the connecting wall 170 proximate the reservoir 120 is defined by a curved end wall as shown and it can be seen that this curved end wall also is a sloped or beveled surface in that like the side walls of the adjacent waffle sections 130, this curved end wall tapers outwardly in a direction away from the top surface of the connecting wall 170 while at the same time being curved (concave). Fluid that thus flows out of the reservoir 120 can thus flow onto the connecting wall (web) 170 by flowing down this curved and sloped end wall that defines the closed end of the connecting wall 170. Once between the side walls of the adjacent waffle sections 130, the fluid, such as syrup, flows along the top surface of the connecting wall (web) 170.

As shown in the cross-sectional views of FIGS. 6-7, which are taken through two opposing connecting walls 170, the connecting walls 170 can have a varying thickness. In particular, the innermost end portion of the connecting wall 170 can be thinner than the outermost end portion of the connecting wall 170.

The reservoir 120 is preferably of a size that holds an appreciable quantity of syrup or other liquid filling to allow a person to dip each of the severable waffle section 130 in the syrup for dressing and flavoring the waffle sections 130.

As shown in the figures, the connecting walls 170 that connect adjacent severable waffle sections 130 are preferably formed at intermediate portions of the adjacent severable waffle sections 130 as measured along a height of the severable waffle sections 130. In other words, the connecting walls 170 extend between center portions of adjacent waffle section 130 as measured along the heights thereof as shown. This also creates a symmetric appearance.

In the illustrated embodiment, the center portion 140 of the severable waffle section 130 has a sloped construction and as shown in the cross-sectional view of FIGS. 7-8, the center portion 140 can have a variable thickness. More specifically, the center portion 140 can be downwardly sloped in a direction away from the integral reservoir 120. Thus, the innermost section of the center portion 140 represents a high point relative to the outermost section of the center portion 140 which represent a low point. The thickness of the center portion 140 can differ from region to region in that, as shown, the outermost section of the center portion 140 (adjacent the outer wall portion 156) represents an area of minimum thickness of the center portion 140. As shown, each waffle section 130 has a recessed central portion that can act as a reservoir in and of itself and, as discussed herein, when the waffle section 130 is detached, the waffle section 130 can act as a spoon which can be dipped into the main reservoir 120 for the collection of the contents thereof. The detached waffle section 130 and the recessed central portion thereof thus maintain their integrity since the waffle section 130 breaks along the natural tear line (wall 160).

It will also be appreciated that the shape and number of severable waffle section 130 can vary. For example, while the illustrated embodiment depicts a six-petal flower defined by the six severable waffle sections 130, the number of severable waffle sections 130 can be less or more than six. In addition, the shape of the severable waffle sections 130 is not limited to that depicted. In any event, the waffle sections 130 are constructed for severability as discussed herein in that the waffle section 130 in effect has scores that promote the severing of one discrete waffle section 130 from both the integral reservoir 120 and the adjacent waffle sections 130.

As described herein, maintaining the integrity of the reservoir 120 results since the side wall 124 of the reservoir 120 is not breached (e.g., torn) to such a degree that the hollow interior of the reservoir 120 is exposed so as to provide an outlet for the contents of the reservoir 120 to flow outwardly therefrom.

While the figures illustrate a symmetric waffle 100 in that both the top surface 112 and the bottom surface 114 include a reservoir 120, it will be appreciated that the waffle 100 can be constructed such that the reservoir 120 is only formed along the top surface 112. The bottom surface can be formed so as to be patterned or can be generally smooth. In addition, it will be understood that the waffle 100 can be constructed so that the reservoir 120 on one side of the waffle is larger (has greater volume) than the reservoir on the other side of the waffle 100.

FIG. 9 is an exemplary cooking assembly 200 for making the waffle 100. The cooking assembly 200 can be in the form of a waffle iron that has a first plate 210 that is pivotally attached to a second plate 220. As is known, each of the first plate 210 and the second plate 220 has a pattern 215, 225, respectively, that is configured to form the waffle 100 in the shape shown in the figures. In particular, the patterns 215, 225 have cavities and raised portions that receive batter and upon cooking forms the waffle 100 as illustrated herein.

As shown in the figures, the central integral reservoir 120 is elevated relative to the surrounding structures, in this case the surrounding severable waffle sections 130, and is walled off (by side wall 124) to ensure that the contents can be contained, even while other sections (i.e., the severable waffle section 130) are torn off/removed. Conversely, the elevated reservoir 120 is designed with curved/contoured edges to permit surplus liquid/fillings to radiate out from the center, filling pre-designed channels/grooves that direct it 360 degrees from the center, thereby achieving more complete surface area coverage (a goal) with less spillage. As shown, the top edge 125 of the side wall 124 can be curved to permit the surplus liquid/filling to flow outwardly therefrom. In addition, the thin connecting walls 170 that connect the severable waffle sections 130 define discrete flow paths that extend radially outward from the reservoir 120. The connecting walls 170 can be thought of as being spoke-like structures that are circumferentially spaced apart and extend radially from the reservoir 120. Syrup and the like that flows within these areas thus flows in a spoke-like pattern.

It will also further be appreciated that the severable waffle sections 130 are in the form of spoon shaped canted petals that are configured to: a) easily detach from the main structure (i.e., the central reservoir 120 and/or other waffle sections 130) without disturbing the integrity of the whole, b) serve as a “spoon” for easy dipping into the central well/pool (reservoir 120) of toppings c) fit the finger and thumb ergonomically, d) “petals” protrude and are scaled for easy bite-ability as the waffle 100 is held in one hand. Note that the profile of the “petal” is not flat; rather, it is designed to descend from the center to encourage the flow of fluid into the pre-formed channels (e.g., channels defined by the connecting walls 170) that promote and channel the fluid to flow along the waffle in a way that increases the coverage of the syrup on the waffle 100.

Loaded or Pre-Loaded Variations

The flower-shaped waffle 100 can be manufactured to include a central fill of edible toppings that are frozen and then remain in the reservoir 120 when reheated. It can also be manufactured and distributed without pre-loading any filling: the reservoir 120 is empty but can then receive the customized fillings applied by the consumer.

In one embodiment when the waffle is pre-loaded, the amount of the filling (e.g., syrup or jam) that is disposed within the reservoir 120 is calculated in view of the thermal expansion of the filling in that the amount of the filling is selected such that during a reheating operation, the volume of the filling in the reservoir 120 expands and breaches the side wall 124 of the reservoir 120. This results in the filling flowing over the top edge of the side wall 124 of the reservoir 120 and the construction of the waffle 100 is such that the filling overflow is directed into the radially extending flow channels defined by the connecting walls 170. In this manner, the flow is spread out over the waffle 100 for improved coverage as opposed to flowing onto the plate on which the waffle rests. In addition, the spoon shaped individual waffle sections with their sloped construction also promotes flow of syrup or the like therealong, thereby achieving improved coverage of the syrup.

The severing of the sections 130 thus results in severing of the webs 170 and the front portion of the section 130 near the reservoir 120.

It will be appreciated that the waffle 100 is purposely formed and designed to have functional purpose in that the shapes of the severable sections 130 and locations and constructions of the connecting walls 170 and reservoir 120 are selected to more optimally distribute syrup to achieve more even and thorough coverage of the syrup within the form of the waffle (and not the plate on which the waffle rests). It will further be appreciated that the waffle 100 can be formed using any number of ingredients. For example, stiff batter for the waffles can be made from flour, butter, brown sugar, yeast, milk, and eggs. However, as mentioned, there are many types of waffles and thereof the ingredients vary depending upon the type of waffle being made. Even within one region, there can be different types of waffles and in particular, American waffles vary significantly. Generally denser and thinner than the Belgian waffle, they are often made from a batter leavened with baking powder, which is sometimes mixed with pecans, chocolate drops or berries and may be round, square, or rectangular in shape. Belgian waffles are a North American waffle variety, based on a simplified version of the Brussels waffle. Recipes are typically baking soda leavened, though some are yeast-raised. They are distinguished from standard American waffles by their use of 1½″ depth irons.

In accordance with the present invention, the waffle 100 can be formed of plant-based ingredients (e.g., almonds, ground nuts, carrot/vegetable purees, beet puree and powder, malted barley) that replace dairy and eggs yet deliver a similar mouthfeel, experience, and enhanced nutritional profile. The ingredients thus are selected to produce a healthy waffle. Certain center filling materials (e.g. apricot or berry compotes and jams) can be formulated with sufficient pectin and other natural gelatins to ensure a semi-solid form that liquifies when reheated, improving the experience, convenience, and surface area coverage of the waffle 100.

Some or all of the following ingredients can be used to make waffle 100:
100% Whole Wheat Flour
   Containing a blend of whole wheat flours, our waffles pack a great source of protein, dietary fiber, B vitamins, minerals, and antioxidants. These nutritional benefits have been shown to help reduce the risks of conditions such as heart disease, type 2 diabetes and obesity. The flavor of whole wheat provides a wholesome and natural, nutty-sweetness.
Flax Seeds
   Ground flax seeds contribute numerous nutritional benefits including protein, dietary fiber, Omega 3 and micro-nutrients that are essential to a ‘Heart Healthy’ diet. In addition to their nutrition fortitude, flax add great texture and a nutty, toasted seed flavor.
Olive Oil
   Olive oil is a monounsaturated fat that contains several healthy polyphenol-antioxidants and is high in oleic fatty acids. In the baking process, olive oil contributes a light, crispy textural crunch to the waffles.
Barley Malt
   Malted barley adds a delicious malty-toasted flavor, contributes to caramelization in the baking process and allows for a reduction in sugar. Barley malt is high in protein, B & E vitamins and has been shown to help reduce cholesterol.
Almonds
   Almonds and almond milk taste great and are good for you. As a good source of protein, vitamin E, Biotin, Thiamin, Magnesium, Riboflavin (B2), and monounsaturated fat, almonds give the waffles flavor and textural character.
Carrot Puree & Beet Powder
   Offering nutritional benefits such as vitamins A, C, & B as well as several healthful antioxidants, carrots and beets provide natural color, sweetness and flavor.
Fruit Purees & Juices
   Because we use natural fruit purees and juices that are not from concentrate, more wholesome and nutritional benefits are retained. Ingredients such as apricot puree thickened naturally with fruit pectin creates a delicious fruit topping.
Maple
   Maple and waffles are a natural fit and a flavor profile that transcends the breakfast foods category. The use of maple as a natural sweetener contains several phytochemicals and antioxidants as well as B vitamins and minerals.
Oats
   Oats are a great source of dietary fiber and have been shown to help in the reduction of cholesterol as a regular part of diet. Additionally, oats are rich in protein, B vitamins and minerals and possess antioxidant characteristics in digestion.

### EXAMPLES

The following examples set forth different waffle ingredient formulations that can be used to form the waffle 100.

Plain

| | Gr |
|---|---|
| Formula | |
| Wildflower waffle-Plain | |
| Ingredient | |
| Whole Wheat Pastry | 57.5 |
| Whole Wheat | 172.5 |
| Baking Powder | 6 |
| Salt | 2.6 |
| Sugar | 64 |
| Oil | 120 |
| Ground Flax, Golden | 30 |
| Water | 87 |
| Vanilla | 8 |
| Almond Milk | 355 |
| malt powder | 25 |
| almond meal | 30 |
| Totals | 957.6 |

CranRaspberry

| | Grams |
|---|---|
| Formula | |
| Wildflower waffle-Cranraspberry | |
| Ingredient | |
| Whole Wheat Pastry | 57.5 |
| Whole Wheat | 172.5 |
| Baking Powder | 6 |
| Salt | 2.6 |
| Sugar | 64 |
| Oil | 120 |
| Ground Flax, Golden | 30 |
| Water | 87 |
| Vanilla | 8 |
| Almond Milk | 355 |
| malt powder | 25 |
| almond meal | 30 |
| Beet Powder | 30 |
| Totals | 987.6 |

Apricot Almond

| | Grams |
|---|---|
| Formula | |
| Wildflower waffle-Apricot Almond | |
| Ingredient | |
| Whole Wheat Pastry | 57.5 |
| Whole Wheat | 172.5 |
| Baking Powder | 6 |
| Salt | 2.6 |
| Sugar | 64 |
| Oil | 120 |
| Ground Flax, Golden | 30 |
| Water | 211 |
| Vanilla | 8 |
| Carrot Puree | 211 |
| malt powder | 25 |
| almond meal | 30 |
| Almond Extract | 6 |
| Totals | 943.6 |

Fruit Marmalades

| | Gr |
|---|---|
| Formula | |
| Pectin based marmalade | |
| Ingredient | |
| Fruit Puree | 248 |
| Sugar | 78 |
| NH pectin | 26 |
| Sugar | 22 |
| Lemon Juice | 14 |
| water | 40 |
| Totals | 428 |

Chocolate Hazelnut

| | Gr |
|---|---|
| Formula | |
| chocolate hazelnut paste | |
| Ingredient | |
| 55% semi-sweet chocolate | 200 |
| water | 190 |
| oil | 10 |
| cocoa powder | 20 |
| cinnamon | 1 tbsp |
| hazelnut paste | 50 |
| Totals | 470 |

Additional Information:
Batter can be cooked at 375 degrees Fahrenheit for approximately 7-9 minutes in a Teflon coated mold.
During the baking process, the batter is piped into the hot mold, the mold is then closed and the waffle iron is then inverted to allow the batter to reach both sides of the mold evenly.
The fillings (pectin-based) are thermal reversible, meaning they are firm when frozen, jelly/jam-like in texture when heated. The thermally reversible trait can be accomplished by the use of NH pectin.
This pectin can be used to create firm fillings that when heated become somewhat liquid, and then when cooled become firm and rigid.

Notably, the figures and examples above are not meant to limit the scope of the present invention to a single embodiment, as other embodiments are possible by way of interchange of some or all the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A waffle comprising:
a body having an integral reservoir formed therein with a plurality of severable waffle sections that are connected to the integral reservoir and configured to be severable from the integral reservoir such that the integrity of the integral reservoir is maintained when each severable waffle section is severed from the integral reservoir.

2. The waffle of claim 1, wherein the integral reservoir is formed centrally within the body and the plurality of severable waffle sections are formed radially about the integral reservoir.

3. The waffle of claim 1, wherein the plurality of severable waffle sections are formed circumferentially about the integral reservoir.

4. The waffle of claim 1, wherein the integral reservoir is defined by a solid bottom wall and a continuous side wall that surrounds and extend upwardly from the solid floor, the integral reservoir being open along a top surface of the waffle.

5. The waffle of claim 4, wherein a top edge of the continuous side wall is curved.

6. The waffle of claim 4, wherein a top edge of the continuous side wall is elevated relative to a topmost portion of each of the plurality of severable waffle sections.

7. The waffle of claim 1, wherein each severable waffle section has a spoon shaped to permit grasping and severing of the severable waffle section from both the integral reservoir and any adjacent severable waffle section.

8. The waffle of claim 1, wherein the plurality of severable waffle sections are interconnected to one another.

9. The waffle of claim 1, wherein each severable waffle section includes a center portion that is enclosed by a continuous peripheral side wall that protrudes above a top surface of the center portion.

10. The waffle of claim 9, wherein the top surface of the center portion is downwardly sloped in a direction away from the integral reservoir.

11. The waffle of claim 1, wherein a first scored region is formed between a raised side wall of the integral reservoir and a raised side wall of each severable waffle section for creating a first tear area along which the respective severable waffle section can be detached cleanly from the raised side wall of the integral reservoir and at least one second region between adjacent severable waffle sections for creating a second tear area along which one severable waffle section can be detached cleanly from the adjacent severable waffle section.

12. The waffle of claim 11, wherein the first scored region has a thickness less than a thickness of each of the raised side wall of the integral reservoir and the raised side wall of the severable waffle section and the second scored region is defined by a connecting wall that extends between and is connected to adjacent severable waffle sections and has a thickness less than a thickness of the side wall of each of the severable waffle sections.

13. The waffle of claim 1, further comprising a frozen filling that is disposed within the integral reservoir, the volume of the frozen filling being selected such that during heating and thawing thereof, the frozen filling expands in volume and flows over a top edge of a continuous side wall that defines the integral reservoir.

14. The waffle of claim 13, wherein adjacent severable waffle sections are connected by a connecting flange that is lower than side walls of the severable waffle sections, thereby defining a flow channel that is in fluid communication with the integral reservoir and can receive the filling after the filling flows over the continuous side wall of the integral reservoir.

15. The waffle of claim 1, wherein each severable waffle section is a flower petal shaped and includes a center portion that is enclosed by a continuous peripheral side wall that protrudes above a top surface of the center portion, the severable waffle section having a downward slope in a direction away from the integral reservoir.

16. The waffle of claim 15, wherein an outer portion of the severable waffle section is wider than an inner portion thereof.

17. The waffle of claim 15, wherein the center portion is patterned and includes an array of cavities defined by ridges.

18. The waffle of claim 15, wherein the continuous peripheral side wall includes an arcuate inner portion, an opposing arcuate outer portion and a pair of side portions extending between the arcuate inner portion and the arcuate outer portion, wherein the arcuate inner portion is shorter in length compared to the arcuate outer portion.

19. The waffle of claim 1, wherein the body is symmetric about a central horizontal plane in that both an exposed top surface and an exposed bottom surface have one integral reservoir formed therealong with a plurality of severable waffle sections spaced thereabout.

20. The waffle of claim 1, wherein the waffle is free of dairy and eggs and is instead made with plant-based ingredients.

21. A waffle comprising:
a body having an integral reservoir formed therein with a plurality of severable waffle sections, each severable waffle section being detachably connected to the integral reservoir along a first score line and being detachably connected to one or more adjacent severable waffle section by a second score line, the integral reservoir being defined by a continuous side wall that surrounds a floor of the integral reservoir and each of the severable waffle sections includes a center portion that is surrounded by a continuous side wall that is elevated relative to the center portion, wherein the body has a thickness along the first score line that is less than a thickness of both the continuous side wall of the integral reservoir and a portion of the continuous side wall of the severable waffle section that faces the continuous side wall of the reservoir, the second score line being defined along a connecting wall that connects adjacent severable waffle sections by extending between the continuous side walls of the respective severable waffle sections, wherein the connecting wall has a thickness that is less than a thickness of the side wall of each respective severable waffle section.
